(19) United States
(12) Patent Application Publication
(10) Pub. No.: US 2012/0062491 A1
(43) Pub. Date: Mar. 15, 2012

(54) HAPTIC INTERACTION DEVICE AND METHOD FOR GENERATING HAPTIC AND SOUND EFFECTS

(75) Inventors: PHILIPPE CONI, SAINT JEAN D'ILLAC (FR); PHILIPPE AUGEREAU, CESTAS (FR)

(73) Assignee: THALES, Neuilly-sur-Seine (FR)

(21) Appl. No.: 13/231,691

(22) Filed: Sep. 13, 2011

(30) Foreign Application Priority Data
Sep. 14, 2010 (FR) 1003655

(51) Int. Cl. G06F 3/041

(52) U.S. Cl. 345/173; 178/18.03

(57) ABSTRACT

Techniques relating to an interaction device including a touch-sensitive surface and a chassis and making it possible to generate haptic, sound and visual interaction effects. The sound and haptic effects are generated by common structural and electronic means arranged so that the touch-sensitive surface and the chassis behave like a loudspeaker. The techniques also relate to generating interaction effects. The techniques also relate to a visualization device and apply to computers, televisions, telephones, and touch-sensitive tablets, for example. It preferably applies to visualization devices that have a screen with a large diagonal.

### CROSS-REFERENCE TO RELATED APPLICATIONS

This application claims priority to foreign French patent application No. FR 10 03655, filed on Sep. 14, 2010, the disclosure of which is herein incorporated by reference in its entirety.

### FIELD OF THE INVENTION

The field of the invention is that of touch-sensitive screens, also known as “touchscreens”. These screens are sensitive surfaces activated by the finger or the hand of a user or any other activation means and more often than not are used to control a device or a system through a graphical interface. There are a large number of possible uses. Aeronautical applications, in which a pilot can thus monitor and control all the functions displayed by the avionics system of the aircraft, can be cited in particular.

### BACKGROUND OF THE INVENTION

Such interfaces need to offer the user information feedback, for example the change of state of a button, so that the operator can see the transition from non-activated to activated, and thus confirm his or her interaction.

This visualization mode is not very collaborative and errors can occur, associated with the doubt concerning the activation or non-activation of the command, and does not apply in the case of blind commands, the pilot first and foremost having to handle his primary task by looking outside.

For this, use is made of force feedback haptic systems which increase the reality of the interaction by giving feedback concerning the state of the activated object. According to the generally accepted state of the art, this feedback is essentially vibratory or inertial, generating no or little sound, and in a fairly disagreeable manner. An audio system can be added, but it will be fairly difficult to house and to drive. In practice, the haptic devices for aeronautical use are limited by the environmental constraints. Furthermore, the touch-sensitive tablet type devices that generally have a thickness of a few centimeters complicate the possibilities of insertion of an audio system suited to the noisy sound environment of an aircraft cockpit.

In response to the problem of housing an audio system complementing the haptic device, U.S. Patent App. Pub. No. 2008/0055277 and international application Pub. No. WO/2010/065207 are known from the state of the art, the disclosures of which are each herein incorporated by reference in their entireties. These documents describe haptic devices comprising a touch-sensitive surface mounted on a flexible suspension which provides a displacement of the surface with a certain stiffness. The device also comprises an actuator placed at the center or at the periphery that sets the assembly in motion to produce a haptic effect or a sound. The touch-sensitive slab and the actuator thus make it possible to form an acoustic assembly through the vibrations of the touch-sensitive slab.

Furthermore, these haptic devices use a microprocessor-based haptic controller, associated with an effects library, as described in the above-mentioned patents, and this controller is implemented with a dedicated software controller, or “driver”. Furthermore, the applications that use the haptic effect need to have been designed to be compatible with this driver.

To summarize the drawbacks of the existing haptic devices, all the known haptic systems are not very faithful in the reproduction of the haptic effects, and particularly on large screens (diagonal of more than 10 inches for example), producing significant inertial forces liable to make neighboring objects (dashboard, desk, supports, etc.) resonate.

Furthermore, the haptic devices emit sounds originating from the resonance of their various components, accidentally generating a disagreeable noise.

Furthermore, haptic effects generation electronics have to be added to the touch-sensitive screen, with software drivers and dedicated applications.

### SUMMARY OF THE INVENTION

A first objective of the invention is to propose an interaction device comprising haptic functions and sound functions in order to enhance the interactivity of said device.

A second objective of the invention is to propose an audio haptic device suited to an environment with strong constraints, such as, for example, an aircraft cockpit. For this, the haptic device has to be sufficiently compact and reliable to be manipulated by an aircraft pilot during piloting tasks.

More specifically, the invention relates to an interaction device comprising a structural assembly and a control assembly for controlling at least one interaction effect, the structural assembly comprising a chassis forming a cavity, a planar piece formed by a touch-sensitive surface and at least one actuator, and the control assembly comprising a means for generating a touch control signal in response to the actuation of said touch-sensitive surface and a means for driving the actuator to displace the planar piece relative to the cavity of the chassis. The structural assembly is arranged so that the planar piece is held in suspension by the actuator so as to cover the cavity, the control assembly also comprises a computation means, controlled by the touch control signal, capable of generating a first audio signal, comprising a frequency component representing a sound interaction effect, to control the means for driving the actuator, and the structural assembly and the control assembly are arranged so that the actuation of the touch-sensitive surface controls the displacement of the planar piece relative to the cavity of the chassis to generate the sound interaction effect.

Advantageously, the computation means is capable of generating a second audio signal, comprising a first frequency component representing a haptic interaction effect and a second frequency component representing a sound interaction effect, so that the actuation of the touch-sensitive surface controls the displacement of the planar piece relative to the cavity of the chassis to generate said sound effect and said haptic effect simultaneously.

According to a variant, it also comprises a second actuator associated with a driving means, the computation means being capable of generating a third audio signal comprising a frequency component representing a sound interaction effect to control the driving means of the second actuator.

Advantageously, the computation means is capable of generating a fourth audio signal comprising a first frequency component representing a haptic interaction effect and a second frequency component representing a sound interaction effect so that the actuation of the touch-sensitive surface controls the displacement of the planar piece by means of the second actuator relative to the cavity of the chassis to generate said sound effect and said haptic effect simultaneously.

According to a variant, the planar piece also comprises a frame fixed to the periphery of said touch-sensitive surface, the frame having a shape defined to form a vent between the periphery of the chassis and the periphery of the planar piece, the section of the vent being dimensioned so that, when the planar piece is displaced relative to the cavity, the rear wave, at the resonant frequency, is reversed in phase and is added to the front wave.

According to a variant, the outer edge of the frame is curved perpendicularly to the inner edge of the frame fixed to the touch-sensitive surface so as to cover the periphery of the chassis, the space between the periphery of the chassis and the outer edge forming the vent.

Preferably, the actuators are configured to displace the planar piece perpendicularly to the plane of the touch-sensitive surface.

The invention also relates to the method for generating at least one interaction effect for an interactive device as claimed in claim 1. It comprises the following successive steps:

A first step of generation of a touch control signal in response to the actuation of said touch-sensitive surface,

A second step of generation of an audio signal comprising a frequency component representing a sound interaction effect,

A third step of controlling the actuators according to the audio signal so that the actuation of the touch-sensitive surface controls the displacement of the planar piece relative to the cavity of the chassis to generate the sound interaction effect.

According to a variant, in the second step, a signal comprising a frequency component representing a haptic interaction effect is combined with the audio signal and, in the third step, the actuators are controlled according to the audio signal so that the actuation of the touch-sensitive surface controls the displacement of the planar piece relative to the cavity of the chassis to generate said sound effect and said haptic effect simultaneously.

Preferably, the interaction device also comprises a display means, and the method comprises a step of generation of a visual interaction effect on the display means.

A first advantage of the invention is to have sound interaction effect functionalities without adding means specifically for generating the sound. In practice, the very structure of the interaction device behaves like a loudspeaker, the displacement of the touch-sensitive surface over the cavity formed by the chassis of the interaction device making it possible to generate a sound wave. Preferably, the chassis and the touch-sensitive surface have a diagonal of at least 10 inches and the mounting of the frame around the touch-sensitive surface is configured so as to present a stiffness favorable to the generation of sound waves.

A second advantage arising from the creation of an audio signal in response to the touch control command and from the driving of the actuators directly by this same audio signal is that there is no need to incorporate haptic effect control electronics. Unlike in the known systems, the haptic effect is not transmitted by a control link, such a system is described in US 2008/0055277, by way of example. According to the invention, this complex control device is no longer useful, and thus there is no longer a need for specific connections to the haptic device, or for software drivers to implement it.

According to the invention, the touch-sensitive surface is used as a membrane and the actuators are mounted on a rigid frame supporting said surface and are used as audio and haptic transducer. Such a device does not therefore require suspension, since this function is provided by the actuators themselves, which have a stiffness compatible with the reproduction of the sound waves, with a bandwidth ranging from 0 Hz (quasi-static) to over 20 KHz.

### BRIEF DESCRIPTION OF THE DRAWINGS

The invention will be better understood and other advantages will become apparent from reading the following description given as a nonlimiting example and from the appended figures in which:

FIG. 1 represents a diagram of the structural assembly of the interaction device according to the invention.

FIG. 2 represents a graph describing the components of the audio signal driving the actuators.

FIG. 3 represents a diagram of the control assembly controlling the interaction effects of the interaction device according to the invention.

### DETAILED DESCRIPTION

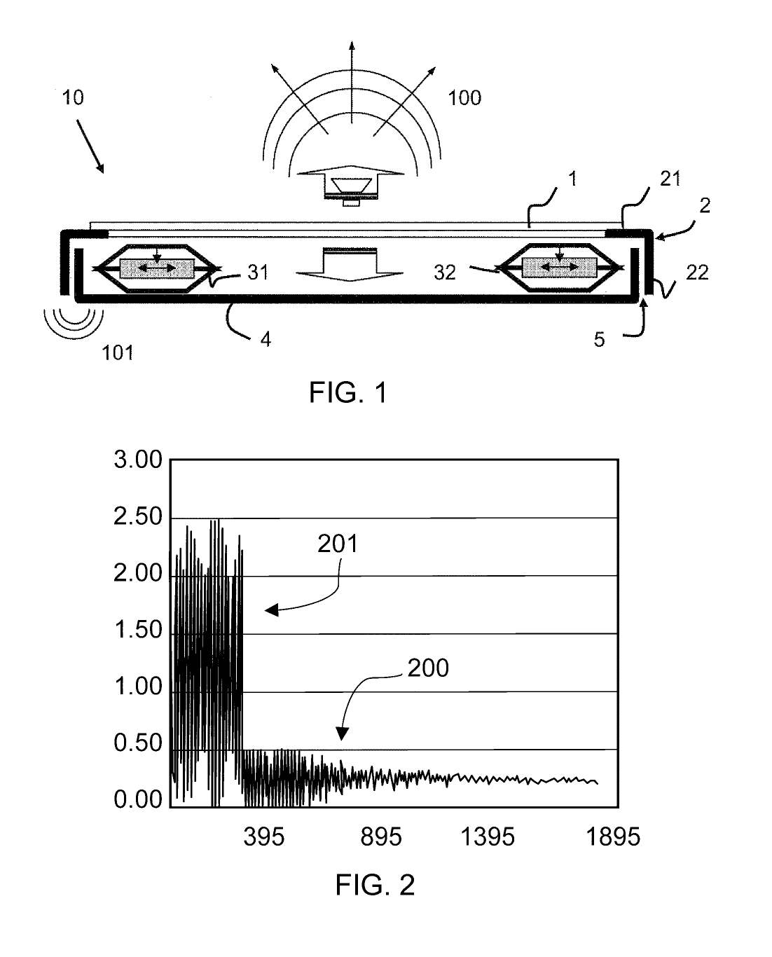

The invention relates to an interaction device 10 comprising a visualization screen for displaying the visual interface that has to be manipulated by the operator. According to FIG. 1, the interaction device comprises a first assembly forming the structure and comprising a chassis 4, one, or preferentially, several actuators 31 and 32 and a planar piece comprising the touch-sensitive surface 1.

The chassis 4 is intended to accommodate the electronic means used to produce the interaction functions of the interaction device. These means comprise the display electronics of the visualization screen (not represented in FIG. 1), the electronics for measuring the touch in terms of position and force on the touch-sensitive surface 1 and the control electronics for the actuators 31 and 32. The chassis 4 is a receptacle in the form of a cavity inside which all of these electronic means are incorporated. The chassis 4 is preferably made of a rigid plastic or metallic material for example. Those skilled in the art can adapt the suitable material to form a rigid receptacle intended to protect and secure the electronic means. For an aeronautical application, the chassis 4 can be fixed in the aircraft cockpit or be removable for a touch-sensitive tablet type use. In the remainder of the description, the chassis 4 is considered to be the reference base in relation to the other components of the interaction device and is therefore considered to be immobile in space.

The type of screen used in the visualization device 10 is not a limiting characteristic of the invention. Preferably, a flat screen technology is used in order to offer a visualization device with little depth. Worth citing for example are LCD screens, plasma screens, devices with LED (light-emitting diode) lighting or OLED (organic light-emitting diode) lighting or any other device for displaying images. The screen can be fixed directly to a face of the touch-sensitive surface or be mounted inside the visualization device between the touch-sensitive surface 1 and the chassis 4 of the visualization device.

The actuators 31 and 32 are, on the one hand, fixed to the chassis 4 and, on the other hand, fixed to the planar piece comprising the touch-sensitive surface 1. The actuators are fixed by any fastening means such as glue, a resin, mechanical means, etc. Those skilled in the art can adapt the fastening means to a specific configuration of the interaction device. An actuator is an electromechanical system that makes it possible to transform electrical energy into mechanical energy more often than not in the form of a movement of a mechanical part. The actuators 31 and 32 perform the function of displacement of the planar piece in a direction perpendicular to the plane of the touch-sensitive surface 1. This displacement in a direction perpendicular to the plane of the touch-sensitive surface allows for the generation of sound waves 100 by displacement of the air molecules around the touch-sensitive surface and the cavity of the chassis 4. Sound waves are created at the level of the front face (outside of the chassis 4) of the planar piece and at the level of the rear face of the planar piece inside the chassis. The driving of the actuators 31 and 32 can also be configured to simulate information feedback, for example, the change of state of a button, so that the operator can sense by touching the touch-sensitive surface 1 the transition from non-activated to activated, and thus confirm his or her interaction. We will hereinafter describe the configuration by which the control assembly generates the information feedback haptic effect.

Various types of actuators that exist on the market can be cited as nonlimiting examples:
Eccentric rotary mass (ERM): this is an eccentric mass which creates radial inertia forces.
Seismic resonant mass (LRM): a mass suspended by a spring is set to resonate by an electromagnetic or electrostatic device.
Electromagnetic: the actuator consists of a frame that can be deformed by the displacement of a core inside a coil.
Piezo bimorph: two types of actuators are used: vibrating beams (piezo beam) and blister disks (piezo disk). These actuators use the shear forces induced by the piezo ceramic covering one or both faces of the actuator. An example of such a device is given in the US Patent App. Pub. No. 2008/0122315 A1, the disclosure of which is herein incorporated by reference in its entirety.
Electrostatic: by capacitive effect, two parallel layers covering the screen are mutually attracted or repelled to stimulate the interacting object.
With shape memory: some materials return to a particular shape when they are subjected to a certain temperature.

There can be one or more actuators depending on the requirements. Preferably, four actuators are positioned inside the chassis.

The touch-sensitive surface 1 is mounted on the front face, the front face being defined as the face presented to the observer and the one presenting the images. As for the screen, the touch-sensitive surface technology used does not limit the scope of the invention. The touch-sensitive surface 1 may be a touch-sensitive layer that is capacitive, resistive or of any other technology that makes it possible to detect the presence of an actuator pointing to an area of the touch-sensitive surface. The touch-sensitive surface 1 is arranged between the actuator and the screen so as to detect the area pointed to by the actuator. The term “actuator” should be understood to mean any object used to point to an area of the screen, that is to say, the finger of the operator or a stylus for example.

The touch-sensitive surface 1 is fixed suspended over the chassis 4 by means of the actuators. The plane of the touch-sensitive surface 1 covers the cavity of the chassis 4. The actuators can be fixed directly to the touch-sensitive surface or preferably to a rigid frame 2 fixed to the periphery of the touch-sensitive surface. In the latter case, the touch-sensitive surface 1 and the frame 2 together form the planar piece. The frame is configured to stiffen the planar piece. The touch-sensitive surface is used as membrane and the actuators are mounted on the rigid frame supporting said surface and are used as audio and haptic transducer. Such a device therefore does not require suspension, since this function is provided by the actuators 31, 32 themselves, which have a stiffness compatible with the reproduction of the sound waves, with a bandwidth ranging from 0 Hz (quasi-static) to more than 20 kHz.

The touch-sensitive surface 1 is generally rectangular suited to the visualization screens on the market. However, any touch-sensitive surface shape is possible.

According to an optimized variant as represented in FIG. 1, the frame 2 has a shape defined to form a vent 5 between the periphery of the chassis 4 and the periphery of the planar piece, the section of the vent 5 being dimensioned so that, when the planar piece 1, 2 is displaced relative to the cavity, the rear wave 101, at the resonant frequency, is reversed in phase and is added to the front wave 100. Such a configuration makes it possible to obtain an enhanced audio system, commonly called “bass reflex” system. The function of this vent is to provoke a phase rotation of the sound wave at resonance to obtain an advantageous combination of the front wave and the rear wave.

According to a variant design of the frame 2, the outer edge 22 of the frame 2 is curved perpendicularly to the inner edge 21 of the frame 2, fixed to the touch-sensitive surface 1 and which extends in the extension of the plane of the touch-sensitive surface 1, so as to cover the periphery of the chassis 4, the space 5 between the periphery of the chassis and the outer edge 22 forming the vent. For a visualization device of large size, that is to say having a diagonal greater than 10 inches, a vent may advantageously be formed by a volume at the periphery of the chassis 4. The volume of the vent 5 surrounding the chassis is characterized by dimensions that are sufficiently great for the interaction device to behave as a “base reflex” system. This vent can be obtained by any shape of the frame 2 provided that the latter is configured so as to coaxially cover some or all of the periphery of the chassis 4. A frame having an edge 22 extending inside the cavity of the chassis is one possible variant to the configuration of FIG. 1.

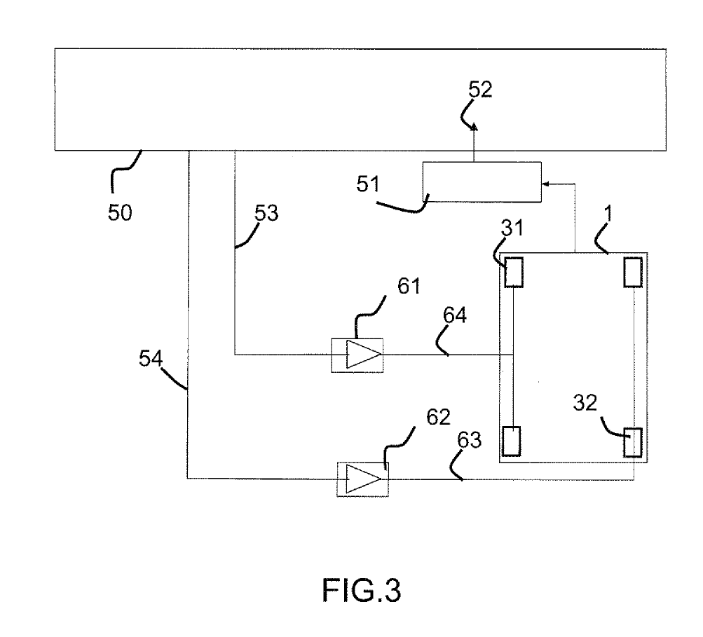

The interaction device comprises electronic means for controlling the actuators 31 and 32 and the touch function. A computer 50 supplies one or more audio signals, two signals according to FIG. 3, 53 and 54, in response to a touch control signal 52. This touch control signal 52 is generated by a computer 51 computing position and/or force measured on the touch-sensitive surface 1. Depending on the position and force data of the control signal 51, the computer 50 generates, on outputs, one or more audio signals 53 and 54. These audio signals supply the driving means 61 and 62 of the actuators 31 and 32. The driving means 61 is an amplifier which modifies the audio signal 53 so as to control the actuators 31 by an audio control signal 64, the actuators being positioned on two corners of the touch-sensitive surface 1. The driving means 62 is an amplifier which modifies the audio signal 54 so as to control the actuators 32 by an audio control signal 63, the actuators being positioned on two corners of the touch-sensitive surface 1.

The computer 50 generates an audio signal whose sound intensity or timbre can be modulated according, for example, to the speed of displacement of the finger, the pressure applied, or the fact that one or more fingers are used in the interaction with the touch-sensitive surface.

The electronic means of the control assembly make it possible to implement a method for generating one or more interaction effects. According to a first variant of the method generating only a sound effect, a number of successive steps are carried out. The method comprises the following steps:
a first step of generation of a touch control signal in response to the actuation of said touch-sensitive surface,
a second step of generation of an audio signal comprising a frequency component representing a sound interaction effect,
a third step of controlling the actuators according to the audio signal so that the actuation of the touch-sensitive surface controls the displacement of the planar piece relative to the cavity of the chassis to generate the sound interaction effect.

According to another variant of the method, it is possible to generate a sound effect and a haptic effect. According to this method, in the second step, the audio signal, represented in FIG. 2, has combined with it a signal comprising a frequency component representing a haptic interaction effect 201 and, in the third step, the actuators are controlled according to the audio signal so that the actuation of the touch-sensitive surface controls the displacement of the planar piece relative to the cavity of the chassis to generate said sound effect and said haptic effect simultaneously. According to this variant, the signal comprises a haptic frequency component 201 and an audio frequency component 200.

According to another variant of the method, it is possible to generate only a haptic effect. In this case, in the second step, the computer 50 generates an audio signal comprising a frequency component representing a haptic effect and a frequency component representing a sound effect imperceptible to the human ear.

Because the computer 50 generates an audio signal 53 or 54 directly supplying the driving means 61 or 62 of the actuators 31 or 32, it is possible to adjust the contribution of the haptic effect, without having to use electronics specifically for the haptic effect, electronics that are generally complex and costly. Thus, the advantage is the reduction of the electronic means for driving the actuators making it possible to obtain a more compact and reliable interaction device that produces audio and sound effects in response to an actuation of the touch-sensitive slab. By virtue of the invention, it is possible to have a sound source, in addition to the haptic effects, without having to use audio and haptic specific hardware electronic means as in the solutions of the state of the art cited. For this, it is sufficient to configure the processor 50 by means, for example, of a virtual mixing console (software). Using the audio signal mixing console, it is possible to adjust the main volume, the sounds, an external audio device, via the software interface. The advantage is in not needing specific applications to benefit from the haptic function; a digital audio file of common format in a software operating system can be used. One of the ways of activating the haptic effect consists in including the spectrum of the haptic effect in a sound file. A large number of applications in an operating system can in fact associate a sound with an action, for example a virtual keyboard emitting a beep each time a key is pressed. It is therefore sufficient to replace the digital audio file corresponding to the beep with another digital audio file according to the invention to obtain a haptic keyboard.

Furthermore, as represented in FIG. 3, the left and right actuators can be used to produce a localized sound on the surface, in order to be able to obtain a spatialization effect and locate the sound at the place of the interaction, and do so by using two sound outputs, which may be the left and right channels of an audio computer. The computer 50 may be a single processor or several processors performing specific functions. For example, the computer 50 may be an electronic module dedicated to audio having two audio channels allowing for spatialization. According to this configuration, the outputs of the audio electronic module are directly connected to the driving means of the actuators. This spatialization configuration makes it possible to strengthen the audio realism by merging the sound source and the place of interaction.

One of the drawbacks of the existing haptic systems is that the strong displacement of the surface results in a disagreeable sound associated with the resonance of the touch-sensitive surface. According to an enhanced variant of the invention, the audio spectrum generated is corrected in amplitude to the resonant frequencies of the slab and according to the superimposed haptic effect, so as not to disturb the haptic interaction effect. It is also possible, according to the invention, to record the undesirable noise produced by the haptic effect, then to add it to the spectrum, while reversing its phase, so as to cancel this noise and retain only the haptic effect.

Furthermore, the use of the audio signal to provoke the sound effect and the haptic effect makes it possible to obtain a perfect synchronization of the haptic effect and the sound effect. Furthermore, the haptic effect is almost instantaneous with the touch control command from the touch-sensitive surface 1 by virtue of the reduced driving electronics of the actuators for the haptic effect. In practice, there is no longer a need to drive the actuators by means of a dedicated haptic control circuit.

The invention applies to the visualization devices that have a touch-sensitive surface and generate haptic and sound effects. The invention relates to any type of visualization appliance (television, display terminal, touchpad, desktop computer, laptop computer, telephone, etc.). In its preferred embodiment, the invention relates to a display device generating haptic and sound effects for an aircraft cockpit used as onboard screen inserted into the cockpit or as removable and portable tablet.

This description has been presented only for the purpose of illustration and description and is not intended to be exhaustive or to limit the disclosed subject matter to the precise forms disclosed. Numerous modifications and adaptations thereof will be apparent to those skilled in the art without departing from the spirit and scope of the disclosed subject matter.

We claim:

1. An interaction device comprising a structural assembly and a control assembly for controlling at least one interaction effect, wherein:
the structural assembly comprises
a chassis forming a cavity,
a planar piece comprising a touch-sensitive surface, and
at least one actuator;
the control assembly comprises
a means for generating a touch control signal in response to an actuation of said touch-sensitive surface, and
a means for driving the actuator to displace the planar piece relative to the cavity of the chassis;
the structural assembly is arranged so that the planar piece is held in suspension by the actuator so as to cover the cavity,
the control assembly also comprises a computation means, controlled by the touch control signal, capable of generating a first audio signal, comprising a frequency component representing a sound interaction effect, to control the means for driving the actuator, and
the structural assembly and the control assembly are arranged so that the actuation of the touch-sensitive surface controls the displacement of the planar piece relative to the cavity of the chassis to generate the sound interaction effect.

2. The device according to claim 1, wherein the computation means is configured to generate a second audio signal comprising a first frequency component representing a haptic interaction effect and a second frequency component representing a sound interaction effect, so that the actuation of the touch-sensitive surface controls the displacement of the planar piece relative to the cavity of the chassis to generate said sound effect and said haptic effect simultaneously.

3. The device according to claim 1, further comprising a second actuator associated with a driving means, wherein the computation means is configured to generate a third audio signal comprising a frequency component representing a sound interaction effect to control the driving means of the second actuator.

4. The device according to claim 3, wherein the computation means is configured to generate a fourth audio signal comprising a first frequency component representing a haptic interaction effect and a second frequency component representing a sound interaction effect so that the actuation of the touch-sensitive surface controls the displacement of the planar piece by means of the second actuator relative to the cavity of the chassis to generate said sound effect and said haptic effect simultaneously.

5. The device according to claim 1, wherein the planar piece further comprises a frame fixed to the periphery of said touch-sensitive surface, the frame having a shape defined to form a vent between the periphery of the chassis and the periphery of the planar piece, the section of the vent being dimensioned so that, when the planar piece is displaced relative to the cavity, a rear wave, at a resonant frequency of the cavity, is reversed in phase and is added to a front wave.

6. The device according to claim 5, wherein the outer edge of the frame is curved perpendicularly to the inner edge of the frame fixed to the touch-sensitive surface so as to cover the periphery of the chassis, the space between the periphery of the chassis, and the outer edge forming the vent.

7. The device according to claim 1, wherein the actuator is configured to displace the planar piece perpendicularly to the plane of the touch-sensitive surface.

8. A method for generating at least one interaction effect for an interactive device according to claim 1, the method comprising:
generating a touch control signal in response to the actuation of said touch-sensitive surface;
generating an audio signal comprising a frequency component representing a sound interaction effect; and
controlling the actuators according to the audio signal so that the actuation of the touch-sensitive surface controls the displacement of the planar piece relative to the cavity of the chassis to generate the sound interaction effect.

9. The method according to claim 8, wherein
in generating the audio signal, a signal comprising a frequency component representing a haptic interaction effect is combined with the audio signal; and
the actuators are controlled according to the audio signal so that the actuation of the touch-sensitive surface controls the displacement of the planar piece relative to the cavity of the chassis to generate said sound effect and said haptic effect simultaneously.

10. The method according to claim 8, wherein
the interactive device further comprises a display means; and
the method further comprises generating a visual interaction effect on the display means.

11. The method according to claim 9, wherein
the interactive device further comprises a display means; and
the method further comprises generating a visual interaction effect on the display means.
